(19) United States
(12) Patent Application Publication
(10) Pub. No.: US 2011/0262733 A1
(43) Pub. Date: Oct. 27, 2011

(54) Fibrous plasticized gypsum composition

(76) Inventors: Peter Paul Roosen, Nanaimo (CA); Thomas P. O'Keefe, Glace Bay (CA)

(21) Appl. No.: 12/766,854

(22) Filed: Apr. 23, 2010

(51) Int. Cl. B32B 13/02; C08B 37/00

(52) U.S. Cl. 428/294.7; 525/54.21; 525/54.22

(57) ABSTRACT

A composition comprising purposely oriented lignocellulosic fiber bound to an inorganic hydrate such as gypsum in the absence of water using a polymer. In a preferred embodiment the polymer is polyurethane. A process for producing the composition and a wide variety of applications of the composition are also described.

### BACKGROUND OF THE INVENTION

This invention generally relates to a composition comprising lignocellulosic fiber bound to an inorganic hydrate such as gypsum using a polymer.

Lignocellulosic biomass refers to plant biomass that is composed of cellulose, hemicellulose, and lignin. The carbohydrate polymers (cellulose and hemicelluloses) are naturally bound to the lignin. Lignocellulosic biomass can generally be derived from two sources: rapidly renewable annual crops and slower growth forest crops.

For the purposes of describing the prior art without the description becoming too lengthy, this discussion will focus on industrial hemp which is one of many types of lignocellulosic biomass from which lignocellulosic fiber can be derived that are known in the prior art. Among the reasons for choosing to focus on hemp are its extraordinarily high strength characteristics relative to weight, the ease of its cultivation and the high annual crop yields achievable. There are, however, many other types of lignocellulosic fiber known in the prior art that are also worthy of discussion where space permits.

Industrial hemp is an annual fiber crop obtained from the stalks of Cannabis sativa. Prior to its' North American prohibition, which was complete by the mid-1950's, industrial hemp was used extensively throughout the world in the making of rope, textiles, and other materials. Clothing, sail cloth, canvas, ship rope and rigging, and paper-like products were produced in the United States and other countries prior to the prohibition and are now beginning to be reintroduced as the prohibitions on industrial hemp that is substantially devoid of any hallucinogenic chemical constituent are coming to an end.

Hemp is a lignocellulosic bast fiber plant, similar to flax, kenaf, jute and ramie that include two major fibers: a long bast outer skin fiber and a hurd core fiber. There are distinct differences between these two respective fiber types that are well known in the art. For instance, the long bast fibers found in hemp have an average length of about 2 inches (50 mm) while the hurd fibers are much shorter with an average fiber length of less than 0.05 inches (1 mm). Both types of fiber can be refined to a desired size by various techniques known in the art.

Due to the annual high crop yields of bast fiber plant crops such as hemp and kenaf, in the range of 5 to 15 tons per acre (10 to 35 tonnes per hectare per year), they are attracting increasing attention as commercially viable sources of renewable industrial fiber for a variety of uses. Supply of preferred wood species has been diminishing for various applications and costs have been correspondingly increasing. The raw material cost of wood is achieving levels where wood-alternates are becoming viable options in the manufacture of various products.

New uses for hemp are being developed, beyond the above longstanding traditional uses for hemp that mainly employed the long outer bast fibers. These developing uses include new types of plastics, composite panels, fuel sources and engineered building materials. The traditional use patterns result in the long outer bast fibers having relatively high commercial value while the hurd portion, that makes up in the range of 60% to 75% of the plant mass, and the process leftovers from the production of long fiber materials have little or no commercial value. They end up as largely as waste products although they are becoming increasingly utilized as fuel sources. To some extent, the hurds are also being increasingly used to produce absorptive materials such as sorbents used as animal bedding. As the uses for hemp increase and the crops become more widely cultivated, the relative costs are expected to decrease due to increasing economies of scale.

There have been new types of fibrous composite articles appearing in the art such as, for example, the ones described in Wasylciw U.S. Pat. No. 6,641,909 and Liang et al. U.S. Pat. No. 7,413,692, the disclosures of which are hereby incorporated by reference, that employ the inner hurd portion of the plant such that there is greater utilization of the entire harvested stalk. These are recent examples in the art that exclusively utilize the hurd fibers that make up most of the hemp plant stalk mass that were previously considered waste materials or materials of limited commercial value relative to the outer bast fibers. Such developments enhance the overall commercial viability of hemp crops. The art is replete with examples of other types of lignocellulosic fibers, especially those derived from wood, that have been used to manufacture fiberboards, composite panels and engineered wood products of various types.

Returning to our discussion of hemp and other bast type fibers, to date, the only known commercial use for the aspirated dust, liberated during the process of decorticating and sorting the outer bast fibers from the crop material, or the smallest subdivision of the plant created by processing and producing materials from the long outer bast fibers, has been as a fuel source. These liberated particles are primarily bast fiber although some relatively small amount of hurd fiber does often end up in the dust stream. In the case of hemp in particular, these particles are often referred to as super short fibers and they are in the size range of 5 microns to 5 millimeters. These are distinguished from the short hurd fibers which, although in the same range of sizes, have different properties. For instance, these super short fibers from the processing of the outer bast fibers have a higher ability to be felted than do the hurd fibers. Short and super-short bast fibers from hemp have a higher tendency to naturally felt than do the similar fibers from other types of bast plants. This tendency to naturally felt reduces or eliminates the need to employ resins or other types of binding agents to convert these super short bast fibers into useful solid products as compared to hurd fibers for which there are few, if any, known techniques for converting them into such useful solid products without the addition of one or more binding agents.

Various approaches are used in the art to orient lignocellulosic fibers such that they are optimized for engineering purposes. There is a wide range of manners in which fibers can be arranged, progressing from omni-directionally dispersed fibers through various types of unwoven arrangements and to fully woven ones. The extent to which fibers can be deliberately arranged or oriented depends on various factors such as the type and length of fiber, strength, flexibility, smoothness, durability, hardness, type of mechanical, chemical, and other processes available and the inherent ability of the fibers to either naturally or be forcibly influenced into particular arrangements or orientations.

For example, in the above discussion of the short hemp fibers, the ones derived from the outer bast fiber portion of the plant have a greater ability to become naturally felted into mats of varying thickness than do the inner hurd fibers. The reasons for this are not as important as being able to take advantage of this useful property to become able to cost-effectively prepare the fibers into materials that can become useful in particular applications.

Other types of fibers such as various types of wood wafers, chips, flakes or strands may have little or no tendency to naturally felt but they can still be oriented in such a way as to enhance the strength of engineered lumber or other products that are composed of wood fiber. Mechanical means are often used to deliberately orient such wood wafers, chips, flakes or strands that are then combined with various natural or synthetic resins, or certain polymers, and eventually consolidated into finished product materials using heated presses and/or other types of equipment.

Gypsum, which is the dihydrate of calcium sulphate, is a widely available compound. It is one of a number of inorganic materials that have one or more hydrate forms and it is arguably the lowest cost mineral on earth that can be converted into useful products. Other examples of inorganic hydrates used by manufacturers include: alumina trihydrate, lime (hydrate forms), borax (hydrate forms) and some types of bentonites and clays that form hydrates. Gypsum, mainly due to its low cost, abundance and wide availability from various sources will be used as an example in the following discussion to, again, prevent this description of the prior art from becoming too lengthy, as was similarly done by focusing on hemp as an example of lignocellulosic fiber above.

The inorganic hydrate used in this invention may be provided from gypsum mines or, increasingly, as a by-product from chemical processes or from the scrubbing of sulfur dioxide from the flue gases of coal burning power generation plants. It also comes from recycling gypsum products. It is inexpensive and chemically inert. Its largest use is in the production of plaster and wallboard, with wallboard production representing over 75% of the total world-wide usage of gypsum. Portland cement also uses large quantities of gypsum. In agriculture, gypsum serves as a soil conditioner. Gypsum is also used as a filler in food and pharmaceutical products such as: breads, cereals, pastas, cakes, pastries and pills.

Wallboard, also known as gypsum wallboard, sheetrock, plasterboard or gyproc, comprises a core of gypsum sandwiched between layers of paper. Although it is widely used, it does have its disadvantages. It has little resistance to cracking or to water. It also has limited fire resistance due to the tendency for the gypsum to crumble as the layers of paper are burned away. Although there are procedures available in the art to avoid or reduce these disadvantages, the known techniques are relatively expensive. Wallboard is mainly used in the construction of homes and work spaces, so any improvements to wallboard need to produce materials that are useful and non-toxic. In this regard, gypsum is ideal because it is a simple inorganic compound that is not toxic. However, the standard existing methods of treating gypsum, for example in the production of wallboards and the like, produces compounds that are rigid, but have the disadvantages that the compound also tends to be brittle and has poor resistance to water.

The vast majority of articles manufactured from gypsum are produced with the interaction of water and gypsum being a key aspect of the manufacturing processes for said articles and materials. The gypsum source may be calcium sulphate dihydrate, either uncalcined or calcined to hemihydrate. Alternatively, the gypsum source may be calcium sulphate anhydrite. The gypsum is rehydrated during product formation to form an interlocking matrix of dihydrate crystals. This property of gypsum has made it a very useful material for use in making wallboards, plaster of Paris and other building materials.

There are numerous examples in the art describing fibrous gypsum articles produced in the presence of water. It is well known that calcined gypsum may be blended with fiber or co-calcined with cellulosic fiber material to form a composite material of cellulosic fibers interlocked with calcium sulphate crystals.

Examination of commercial boards produced from gypsum and fiber in the presence of water reveals that they consist of a compacted mixture of discrete gypsum and fiber materials, i.e. they are more a physical mix than a homogeneous composite. While it might be said that the gypsum provides, or serves as, a binder for the fibers in these boards, it does not appear that there is any appreciable direct physical interlocking or chemical bonding between the gypsum crystals and the fibers. Furthermore, whether because of the way in which these boards are formed, or because of the mechanical mixing of gypsum crystals and fibers, and/or because of the clumping of the fibers and calcined gypsum, these boards often do not exhibit good homogeneity and uniformity of properties; i.e. such as density and strength, over their expanse. The fiber particles are also dependent on having accessible voids within them and/or being of rough or irregular shapes to allow for improved physical bonding upon re-hydration of calcined gypsum and/or formation of gypsum precipitates upon final drying and/or curing.

While there is much in the art describing fibrous gypsum articles produced in the presence of water, there is little in the art that relates to compositions or articles comprised of cellulosic fiber bound to gypsum in the absence of water. In U.S. Pat. No. 6,429,257 to Buxton et al., the disclosure of which is hereby incorporated by reference, some of the difficulties of such a waterless approach are described in considerable detail. Summarizing, the main two problem areas are, first, that the amount of water that reacts with one of the Buxton polymer ingredients is too difficult to predict and control for purposes of the Buxton invention and, second, that the fluid mixtures formed with gypsum exhibit poor flowing characteristics in combination with some polymer ingredients such as ethylene glycol and glycerin. Buxton overcame these difficulties simply by not using gypsum or any other inorganic hydrates. The Buxton invention is directed to a polyurethane casting system and method primarily used to coat wooden door stiles.

There are strategies known in the art to manage these above difficulties without needing to completely avoid using inorganic hydrates. Water levels can be measured and managed through careful process control (times, temperatures, flow rates, cure rates, addition of desiccants, curing agents, etc.). Likewise, flow characteristics can be managed through careful selection of ingredients and process conditions, perhaps avoiding the use of ingredients such as ethylene glycol and glycerin if they are too problematic with respect to the flow characteristics. Gently heating the fluid (while being careful to avoid overheating) and adding ingredients to enhance flow properties are among the methods used to improve fluid flow characteristics.

Polymers are well known for their chemical inertness and wide variety of properties. Those properties can be varied by varying the components of the polymer or, in the case of homopolymers, by varying the amount of polymerization and thus the molecular weight of the polymer.

There are examples in the prior art of polymers used in combination with gypsum or other inorganic hydrates, where such inorganic hydrates are used as fillers. Where used as fillers, such hydrates generally are not combined chemically with the polymers. Engineers and others skilled in the art may select inorganic filler materials for plastics, whether hydrates or not, in consideration of various factors such as cost, availability and various physical and chemical properties.

One important variable in the case of certain applications is how the finished material responds to fire and heat. Choosing a hydrate helps to increase fire resistance as the hydrate begins to decompose liberating water vapor when subjected to fire or direct heat. This helps to extinguish the fire and to also reduce material temperature as the latent heat is taken up by the hydrate as it vaporizes. Unfortunately, this characteristic becomes an important limitation that prevents the use of inorganic hydrates where finished product service temperatures are ever at, near or in excess of the boiling point of water. This temperature limitation also makes it difficult or impossible to use hydrates where elevated temperatures are involved in the manufacturing processes to produce commercial plastics or composite products. High temperature curing using hot presses or other means become quite problematic and in many instances impossible.

Generally, inorganic hydrates are normally avoided for use in plastics and composite products, especially where one or more aspects of the manufacturing process employs elevated temperatures. The above discussion of products such as gypsum wallboard that are produced in the presence of water are an important exception. In such cases, any involved polymers are required to be water-based or at least compatible with aqueous slurries.

Polyurethanes are polymers that include the urethane group. The urethane linkage is formed by a reaction of hydroxyl and isocyanate groups. The high reactivity of isocyanates, together with knowledge of the catalysis of isocyanate reactions, make possible the relatively simple production of a wide range of polymers starting from low to moderate molecular weight, liquid starting materials.

Flexible and rigid polyurethane foams are the most widely available forms of polyurethane commercially available. These formulations typically include isocyanates and polyols (and/or diols which are included in the definition of polyols for the purposes of this description) with suitable catalysts, surfactants and blowing agents that produce the gas for foaming.

The great virtue of polyurethanes is that they are tough, have high load bearing capacity, good load temperature flexibility, resistance to a wide range of solvents and to oxygen, ozone, abrasion and mechanical abuse.

A composition comprising gypsum plasticized by a polymer and containing gypsum in the range of about 40% to 90% by weight is described by Roosen, first named inventor herein, et al. in U.S. Pat. No. 5,344,490, the disclosure of which is incorporated herein by reference. Although the Roosen composition has excellent water resistance and is not brittle, the polymer used therein is substantially more costly than the gypsum component and causes the overall cost of panel products produced from the composition, such as wallboards, to be relatively high as compared to the widely used traditional gypsum wallboard.

The '490 Roosen patent teaches the use of cellulose as a filler. In fact, it goes further in describing a prospective type of board that has, however never been claimed or reduced to practice. The description involved a random fiber aspect and in various instances specifically described using cellulose as a filler. Generally, fiber is added to the plasticized gypsum composition as a filler rather than having the plasticized gypsum composition combined with purposely oriented fiber. There was no discussion of a deliberate orientation of the fibers except for either rolling or pressing wood chips into the composition of the Roosen patent. The types of boards described as “wafer boards” in the Roosen patent rely on hot presses which are not possible to employ in combination with hydrates such as gypsum for reasons including those mentioned earlier in this prior art description.

An important limitation with the polyurethane type of polymer is that the isocyanates employed in the urethane chemistry are generally quite reactive with water. For example, the widely used diphenylmethane diisocyante, which is commonly referred to as MDI, is a liquid urethane resin that reacts vigorously with water, producing carbon dioxide gas in the process that can easily lead to uncontrollable foaming. MDI is also somewhat unable to form bonds with wet or moist materials since the functional reactive components of the MDI will normally react with the water molecules before being able to form bonds with underlying materials. There are polymers that function well in the presence of water but, generally, the types of polymers that are used to produce products with higher quality engineering attributes such as greater strength, flexibility, toughness, water resistance, etc., while being less susceptible to negative attributes such as shrinkage over time, rot, cracks due to drying out, etc., tend to be those used in the absence of water. This is particularly important where products are expected to remain in service for many years with minimum adverse aging characteristics.

Englert U.S. Pat. No. 7,056,460 (the disclosure of which is not intended to be incorporated herein) describes a process for making gypsum fiber board using MDI in a wet process that has the MDI incorporated as part of an emulsion dispersed throughout the fiber. The MDI emulsion is added late in the process and attempts are made to retain a sufficient portion of the MDI during the dewatering process. This process has limited efficacy and produces undesirable MDI-rich waste water while only allowing a fraction of the MDI bonding between fiber and gypsum and other load bearing ingredients of the composition matrix. Additionally, the fiber particles, similarly to those mentioned earlier in this prior art description in relation to commercial boards produced from gypsum and fiber in the presence of water, are also dependent of accessible voids and/or irregular shapes to allow for improved bonding. These tradeoffs to maintain conventional gypsum hydration are important and cannot be easily overlooked. Various experts including Englert have worked toward avoiding or minimizing such tradeoffs with limited success.

The cost of manufacturing wallboards and other building materials is sensitive to the cost of raw materials. Accordingly, it would be desirable to incorporate a low cost fiber system such that the relative amount of polymer used can be reduced while having strength, durability, fire resistance and water resistance remain relatively high as compared to traditional building materials. It is also desirable to eliminate any and all waste streams such that 100% of all ingredients that go into the composition become part of the finished composition.

### SUMMARY OF THE INVENTION

The present invention is directed to provide a useful composition having a number of interesting properties that is comprised of lignocellulosic fiber bound to one or more inorganic hydrates such as gypsum in the absence of water using a polymer. The composition is useful in the formation of acoustical tiles, wallboards, roofing materials, furniture, architectural moldings, doors, floor panels, ceiling panels, movie props, automotive molded components, structural engineered materials and other products. The invention has the great advantage of providing a composition of great interest commercially but being virtually non-toxic and, depending on the choice of components and how they are prepared and combined, of widely varying characteristics. When describing the present invention, all terms not defined herein have their common art-recognized meanings.

The binding of the lignocellulosic fibers and inorganic hydrates such as gypsum is achieved primarily through the use of a polymer that creates chemical links between parts of the fibers and the inorganic hydrates, in effect creating a complex molecule or set of molecules from these components. While not wishing to be bound to any theory, we believe that the selection of polymer components in this invention results in extraordinarily and unexpected good properties such as surprisingly high water resistance due to achieving covalent bonding between the inorganic hydrate and fiber components of the composition. Again, while not wishing to be bound to any theory, we further believe that the prior art compositions of gypsum and fiber produced in the presence of water are largely prevented from achieving such properties due to the interference of water which makes it far more difficult to achieve the types of covalent bonding that are possible in the absence of water.

Adjusting the size and shape of the respective fiber and gypsum particles through various techniques known in the art has significant impact on the properties of the cured composition Likewise, varying the orientation of the fiber components or felting them through natural or forced processes prior to or during the combination with gypsum can have dramatic impact on the properties of the finished products.

The lignocellulosic fiber materials are deliberately oriented through mechanical or other means such as natural or forced felting. Other techniques for orienting the fibers include weaving, pre-stressing long fibers (whether woven or not), mechanically or thermochemically refining and pulping into paper or paper-like fiber mat or lattice materials or using gaseous streams to orient fibers into various arrangements.

Lignocellulosic fiber sources include virgin materials harvested annually in the case of annual crops or less frequently as in the case of forest crops. Other sources include waste fibers from processing or production of other products such as ethanol and other fuels or from recycling lignocellulosic materials. Synthetic sources are also possible although they have not been considered to date for the purposes of this invention.

The final cured composition is either a rigid or flexible solid material, produced from a mixture of solid and liquid components that cure to a solid form after they are combined. It can also become a foamed solid through entrainment of air or another type of gas or through the introduction of blowing agents that are known in the art. The invention includes the pre-cured version of the composition in which one or more of the components are withheld until such time as it is desired to enable the final curing. Solvents, waxes, coloring agents and other additives can be introduced into the composition to aid in the processing and to vary the cured properties.

The surface finish can be varied from a smooth finish to rough texture depending on what is desired for a particular application. Similarly, the color can vary through a wide range as can the strength, density, toughness, hardness and flexibility parameters. Fire resistance can be quite high through the addition of additives and also due to the natural tendency for the inorganic hydrate(s) to liberate water vapor when subjected to high temperatures. Water resistance, as mentioned earlier, is also remarkably high for reasons which are not well understood, an unexpected result.

Certain preferred embodiments of the composition of this invention can be described as being a 100% solids product, a term in the art used to describe compositions that do not contain volatile solvents or other components or ingredients that are liberated during or after the curing process. Such preferred embodiments can also be produced using methods that produce no waste water or other effluent streams, nor any undesirable solid, liquid or gaseous emissions because 100% of all ingredients that are used to compose the composition can become part of the finished products derived from the composition of this invention. It should be noted, however, that it is not essential that the composition of this invention be solvent-free or produce zero emissions. These above characteristics are desirable from an environmental perspective and are preferred, although not required.

Further features of the invention may become apparent to those skilled in the art from a review of this summary and the following detailed description, taken in combination with the appended claims. While the invention is susceptible of embodiments in various forms, described hereinafter are specific embodiments of the invention with the understanding that the present disclosure is intended to be illustrative, and is not intended to limit the invention to the specific embodiments described herein.

### DETAILED DESCRIPTION OF THE PREFERRED EMBODIMENTS

One of the useful products that can be derived from the composition of our invention is an acoustical panel material derived from super short hemp fibers described above. These fibers currently have little or no commercial value. They can be combined with gypsum that is available from recycling processes and other sources also described above that, again, have little or no commercial value. In some cases, there is a negative cost value associated with these materials that often have significant disposal fees associated with them.

This acoustical panel material is used in the construction industry as filler board, substrates, ceiling tile panels and acoustical board. Additional uses for this type of panel material, which can be characterized as low density fiberboard, include doors, automotive mats and other such applications. Prior to combining the super short hemp fibers with gypsum, they are prepared in such a manner as to orient them for maximum strength without the addition of costly resins and other additives. A preferred approach is to naturally felt these fibers through a Fourdrinier process or a similar technique.

A particularly preferred method is to blend the fibers with water within a tank, tub, vat, or other suitable containment unit, agitating the compound material with a mixing or agitating device suitable to severely agitate the volume of the compound material until the fiber strands separate from each other and disperse throughout the liquid, forming a pulpous aqueous slurry.

The degree of fiber presence in the slurry is called the ‘pulp consistency’. ‘Pulp consistency’ is the ratio of fiber to water in the slurry and is an important parameter when producing a strong fiberboard and a smooth surface. Too high a pulp consistency results in lumps that produce a bumpy surface and limits the inter-felting of the source fiber, thereby reducing the strength properties accordingly. Ideally the consistency should be as low as possible for quality purposes but as high as possible for production speed and reduced water usage.

Typically the water temperature would be in the in the range of 0.5 to 50, preferably 25 to 40, degrees C. with fiber present in the slurry from the range of 0.5% to 12%, preferably 1% to 7%, most preferably 2% to 4% (by volume). The pulpous aqueous slurry is agitated for a period of time to ensure separation of any existing bonding, dependant upon the amount of fiber within the slurry and finished characteristics. Typically this is in the range of 2 to 30 minutes, preferably 5 to 15 minutes, most preferably from 8 to 12 minutes, dependant upon the type and rate of the agitation device as well as the fiber in use within the slurry.

The fiber is then removed from the slurry, generally by screening, or draining and scraping, or other methods, from the containment unit. This allows excess liquid to flow away from the fiber within the pulpous aqueous slurry, resulting in a saturated unformed pulpous mass.

The pulpous mass is then conveyed to a forming mechanism (mold, decklebox, or other) that conforms the mass to a pre-determined size and shape. The conformed pulpous mass is then prompted to attain a semi-rigid state by the employment of heat, suction, airflow, and pressing, until the mass achieves the desired formation and characteristics of a low-density semi-rigid fiberboard. This is a result of the aggressive separation of the fiber in the containment unit, then the aggressive prompting to felt, or re-integrate, of the individual fiber strands, where it is believed, it is enhanced with the inherent cellulosic binders within the lingocellulosic fiber feedstock, resulting in a low-density semi-rigid fiberboard. The times and temperatures vary considerably depending on the thickness of the panels being produced and to the extent to which they need to become dry enough to interact and bond with the inorganic hydrate and polymer components without excess moisture causing adverse effects during the curing cycle. Other factors such as minimizing warping and/or deformation during drying also need to be considered by the practitioner during manufacturing operations.

The material may also include other cellulosic material, coloring, perlite and fillers. The targeted material typically has a density of between 3 and 20 pounds per cubic foot and a Noise Reduction Coefficient (NRC) value of at least 45;however end-use of the material may dictate the manipulation to more, or less, extreme valuations. This fiber preparation process is used to prepare dry mats of varying thicknesses in preparation for combination with gypsum and/or other inorganic hydrate(s).

The prepared fibrous mat is drawn along a series of mechanisms to de-water, utilizing forced air, heat, and suction. This combination of catalyst compresses the mat, forcing the articulated fringes of the fiber to intermingle to form a robust chain of fiber, the thickness and density of which is determined by the amount of fiber as well as the intensity of the catalyst. Industrial hemp is exceptionally well suited for this task, as it readily and strongly intermingles as a result of this process, while being allowing a level of porosity for the introduction of additional materials.

Once fully dry, the mat is brought to a point of transport where it is introduced to a contained fog, spray and/or waterless slurry of the preferred inorganic hydrate and polymer which wicks throughout the porous apertures of the mat, permeating the material. Optionally, an excess of the inorganic hydrate and polymer may be introduced such that the finished surface and/or fiber mat is completely saturated and no longer porous. Although it is preferred, it is not entirely necessary for the inorganic hydrate and polymer (or polymer ingredients) to be pre-mixed or pre-blended prior to being introduced to the fiber mat. Ingredients may be progressively introduced, however, the end use product is a cured composition comprised of the purposely oriented fibers, inorganic hydrate and polymer cured into a desired shape or cured into a rough shape that can be later formed, molded, machined or otherwise processed into a finished shape.

The relative amounts of fiber, inorganic hydrate and polymer used to make acoustic panel materials are respectively:
40 to 95, preferably 60 to 85, most preferably 80, parts by weight fiber,
3 to 40, preferably 10 to 25, most preferably 15, parts by weight gypsum,
1 to 20, preferably 2 to 5, most preferably 5, parts by weight polymer.

There is such a wide range in the above parameters because the exposed surface or face of the acoustic panel product for some applications does not need to have the same composition as the backside of said panel, although it can be a somewhat homogenous material for other applications. For instance, as a ceiling tile which has low hardness, toughness and strength requirements, the inorganic hydrate and polymer would be concentrated at just the visible surface of the product whereas for wall panels, filler boards or automotive applications, a more uniform strength may be required throughout the entire thickness of the product. The above ranges at their broadest cover the range of applications while the most preferable 80:15:5 parts by weight for the respective fiber, inorganic hydrate and polymer weights are for an acoustical panel material that although stronger than required can be used as a ceiling tile which is where there are large markets. In practice, however, the ceiling tiles are expected to have the weights biased toward the minimization of costs which is generally achieved by minimizing the polymer portion. That suggests the ratio would move closer to 95:3:2. Another possibility is that for ceiling tiles, particularly where there is a negative cost for using recycled gypsum, the amount of gypsum and polymer can be increased toward higher strength and higher fire resistance such that the composition might move toward say a 40:40:10 ratio. Costs are an essential aspect with respect to the ceiling tile markets which can often be very price sensitive.

For the fog, spray and/or waterless slurry of preferred inorganic hydrate and polymer of the previous paragraphs (and following paragraph), the following dry ingredients blended together at a temperature between 20 degrees C. and 95 degrees C. (preferably 40 to 85, most preferably 70 to 80, degrees C.) are quite suitable:
40 to 90, preferably 50 to 80, most preferably 75, parts by weight gypsum,
2 to 35, preferably 10 to 25, most preferably 17, parts by weight isocyanate (MDI),
5 to 60, preferably 25 to 50, most preferably 39, parts by weight castor oil (standard industrial, crude or no. 1 grade),
1 to 5, preferably 2 to 3, most preferably 2, parts by weight titanium dioxide,
0 to 5, preferably less than 2, parts by weight of suitable desiccant such as a synthetic zeolite with the amount to be determined in response to moisture levels found in the other ingredients,
1 to 5 parts by weight of suitable coloring pigments with the amount and type dependent on the desired color as determined from color matching,
small quantities of a curing agent such as dibutyl tin dilaurate, tertiary amine or such other suitable catalyst/accelerator as are readily determined by someone of ordinary skill in the art,
additional ingredients as would be determined by someone of ordinary skill in the art to adjust properties toward the final desired characteristics of the finished article.

Examples would include addition of a small amount (1 to 5 parts by weight) of a sucrose polyol to make such article of manufacture more rigid. Other such ingredients include but are not limited to polyol additives known in the art that enhance product tear strength, elasticity, hardness, toughness or pliability. Further additives include flow enhancers, waxes, ultra-violet inhibitors, anti-bacterial agents, fillers, etc.,
traces of residual water, or tiny amounts of added water, to act as a blowing agent to create foaming within the product to reduce density. Other blowing agents known in the art such as alcohols, alkanes, refrigerants or entrained gases can be used instead of or in addition to water,
solvents such as styrene monomer to facilitate improved blending and/or better interaction between the other polymer, inorganic hydrate and lignocellulosic fiber components.

Another preferred embodiment includes the introduction of longer cellulosic fibrous materials, layering them to form a symmetrical array of fiber, either in a dry format or exposing them to the same combination of technical events described above. The profile of the material is predetermined and optimally includes width and density of the material, according to intended end-use. This material is then combined with a fog, spray and/or waterless slurry of inorganic hydrate and polymer, which again follows the apertures within the material to fill voids to the extent desired and also gain bond strength. This is then followed by a secondary layer, or strata, of shorter or other cellulosic material which is then pressed into the associated materials to form a laminate.

In yet another preferred embodiment, wood, bast plant or other lignocellulosic fibers can be oriented such that the strands are substantially parallel using well established and readily available processes and equipment used in the engineered wood industry. Strand orientation can be achieved with minor modification to machines and methods used for orienting wood strands for a type of panel product commonly known as oriented strand board or “OSB”. Such machinery and methods which are also used for orienting strands of cereal straw and hemp fibers are well known in the art. Similarly, machinery and process have been developed for engineered structural wood products commonly known as long strand lumber or “LSL”. The main difference between the OSB and LSL is that the OSB tends to use wood wafers to make panel products normally used as construction sheathing whereas the LSL uses much longer strands of wood to make lumber products such as those used as beams or slender engineered wood products that are normally used in load bearing construction applications.

In one example, strand orientation is accomplished using a mat orienter which includes a plurality of spinning discs. In one example, the pieces are vibrated on a corrugated panel before being held or pressed. The corrugations cause the strands to align. In another example, the strands may be dropped on parallel-aligned vertical bars placed in the form of a spaced grid with a width that is less than the strand length. Vibrating or shaking the strands on the grid causes the strands to fall through and be substantially oriented in one direction. Layers having cross-orientation may be produced where the strand orientation in one layer is oriented perpendicular to the strand orientation in other layers in order to facilitate stiffness and strength both parallel and perpendicular to machine manufacturing direction.

For example, a sheathing or panel product may have a core and two face layers where the orientation of the strands in the core layer is perpendicular to the orientation of the strands in the face layers. Such panel or sheathing products tend to have relatively uniform albeit not very high strength in all directions. For high strength lumber products, the fibers tend to all be oriented in a parallel arrangement to maximize longitudinal tensile and compressive strengths, as well as maintain high bending and transverse shear strengths, while the product can be relatively easily split along the longitudinal dimension. For the purposes of this invention, the orientation of the fibers are an important consideration relative to the engineering requirements for each respective product or set of products produced from our composition. There are fairly well developed engineering strength standards for different types of lumber and panel products that must be met or exceeded for certain applications and/or to achieve certain industry and/or customer certifications.

In a preferred embodiment, a fog, spray and/or waterless slurry of inorganic hydrate and polymer such as the one described earlier, is introduced to the dry oriented strands between layers although it is also possible to introduce the hydrate and polymer to the completed mat as in the earlier examples. The preference is to introduce the hydrate and polymer between layers to ensure there is a relatively consistent amount of bonding throughout the entire thickness of the fiber mat which is difficult to achieve in relatively thick mats by drawing the hydrate and polymer through from one side or the other. Pre-treating the fibers with the hydrate and polymer prior to orienting them tends to be quite difficult although it is also desirous to be able to do so as a method of preparing the fibrous composition. Pre-treated fibers tend to be quite sticky and difficult to orient and the equipment is easily fouled whereas the difficulty decreases when introducing the hydrate and polymer progressively between layers or after the mat has been somewhat prepared from oriented fibers. Again, although it is preferred, it is not entirely necessary for the inorganic hydrate and polymer (or polymer ingredients) to be pre-mixed or pre-blended prior to being introduced to the fiber mat.

The relative amounts of fiber, inorganic hydrate and polymer used to make OSB and/or LSL fiber based materials are respectively:
40 to 90, preferably 60 to 85, most preferably 70, parts by weight fiber,
5 to 40, preferably 10 to 25, most preferably 15, parts by weight gypsum,
5 to 30, preferably 10 to 20, most preferably 15, parts by weight polymer.

There is again, as was the case for the low density acoustical material described earlier, a large variation in the range of components that make up the ratio of fiber, preferred inorganic hydrate and polymer. The reasons are somewhat different in the case of these higher density wood fiber based products made from our composition. For instance, where completely filling voids to give a smooth surface finish that is highly water resistant and also has increased fire resistance relative to conventional OSB or LSL products is more important than strength, the gypsum is maximized whereas if strength is the main requirement, the fiber is maximized. The 70:15:15 parts by weight or weight percent ratio of fiber, inorganic hydrate and polymer provides fair void filling, some improved water resistance and enhanced fire resistance relative to conventional OSB and LSL products without greatly reducing the product strength. However, the ratio might shift toward a 80:5:15 where strength is paramount or in the other direction toward say 40:40:20 where strength is not nearly important as are the smoothness, water and fire resistance aspects.

Another preferred embodiment involves using mechanically shredded or pulverized paper as a source of lignocellulosic fiber for the composition. For instance, it is well known that waste gypsum wallboard consists largely of gypsum and the paper used to make up the outer faces of the wallboard product. Typically, in the case of dry gypsum wallboard waste, the paper found in waste gypsum wallboard represents in the range of 5% to 15% of the weight of the waste material, the balance being substantially gypsum. Waste gypsum wallboard is often in a wet state due to exposure to the elements so it may be required to dry the material prior to incorporating in within the composition of the present invention.

For this preferred embodiment, the wallboard waste materials are shredded or pulverized such that the paper becomes small particles that are sometimes referred to in the art as being “fluff”. Whether the waste material is wet or dry when being shredded or pulverized, the material needs to be reasonably dry, although not dehydrated, prior to being combined with the polymer in this invention. To maximize the strength of the finished material composed of this combination of gypsum, fiber and polymer in this embodiment, the fiber in the form of fluff is purposely oriented, either as the sole fiber or in combination with the other fibers stated herein, such that there is increased strength in the directions in which the finished products produced from the composition are expected to be subjected to greatest stress.

For instance, where the composition is used to manufacture roofing shingles or rolled roofing material, the fluff is oriented such that there is sufficient strength in the longitudinal, latitudinal and transverse directions to take up the respective loadings in each direction. Such roofing or exterior wall covering materials are often installed using nails with heads or staples that should not easily tear through the shingle or rolled roofing material after it has been installed when said roof is subsequently subjected to wind storms or the like. For practical purposes, in this embodiment, the fiber is stirred or blended omni-directionally into a liquid blend of the inorganic hydrate (gypsum in the case of recycled waste wallboard), fiber (fluff in this case of recycled waste wallboard) and polymer (polyurethane or other suitable one). Upon final cure, the fiber is omni-directionally oriented such that there is sufficient strength in all directions, resulting in a strong enough product and, more specifically, one that is resistant to nail or staple pull-through.

The relative amounts of fiber, inorganic hydrate and polymer used to make ‘fluff’ fiber based materials are respectively:
5 to 30, preferably 5 to 15, most preferably 10, parts by weight fiber,
40 to 90, preferably 50 to 80, most preferably 65, parts by weight gypsum,
5 to 50, preferably 10 to 40, most preferably 25, parts by weight polymer.

In the case of using the fluff derived from shredding and/or pulverizing waste gypsum wallboard, the simplest and least costly approach is to simply use the fiber that comes in as part of the waste wallboard being converted into architectural moldings, marine coatings, industrial coatings, road repair materials, parking structure coatings, roofing materials and/or other products without having to buy additional fiber or gypsum from other sources. However, the ratios can be adjusted to suit particular engineering or customer requirements or to account for variations or irregularities in the supplied materials. For instance, the fluff fiber percentages may become reduced if the incoming waste wallboard is of poor quality and needs to be blended with higher quality gypsum and/or other inorganic hydrate from other sources to maintain a certain product quality such as elasticity or flexibility. Alternatively, additional fiber might need to be added for products such as rolled roofing where additional nail pull-through resistance is required.

For the purposes of achieving a good distribution of the fluff fiber in an omni-directional manner, blending temperatures should be in the range of 20 to 95, preferably 40 to 90, most preferably 70 to 80 degrees C. and the blending should be done using high shear mixing equipment and processes for a minimum duration of 5 to 30 minutes, preferably 15 to 25 minutes and most preferably 20 minutes at such temperature. There is, however, no limitation as to how long the blending can continue once the initial blending has been carried out. For instance, in a manufacturing plant, it is a good practice to maintain the blend at temperature and with constant agitation until such time as it is packaged for delivery to another location or converted into finished solid products at the manufacturing plant in which it was initially blended.

Our composition can be used to manufacture interior and exterior doors. The processes for producing cost-competitive doors need to be carefully optimized to minimize costs. This need to minimize costs is also true for all the previous preferred embodiments and examples, but, due to the typical door being much thicker than most other materials described earlier, there is a need to give special consideration to manufacturing the door so that there is minimal material used in the core of the typical door. Currently produced doors tend to be hollow products comprised of rails and stiles at the top, bottom and sides combined with an inside and outside skin. The stiles and rails are typically made from engineered wood with the skins being pressed from wood fiber composites or metal sheets. There are still solid wood doors available but they no longer represent the majority of the market. One way to produce a door partly from our composition is to use existing skins, stiles and rails and simply use relatively small amounts of our composition foamed to a high degree to partly or completely fill a hollow core door to make it more solid and fire resistant. An existing interior residential door type that is not fire-rated can be uprated to be used in commercial applications where higher prices can be obtained if the core is partly or completely filled with our fire resistant composition.

Alternatively, two halves of a door (each being half the total thickness) can be pulled from molds that have the composition solid forming the skin with foamed composition making up the balance. The two halves can be bonded together with the composition or by other means. For additional strength, stiles and rails made from engineered wood or from the composition with OSB, LSL and/or other lignocellulosic fiber can be inserted as the door is being molded. In this manner, it is possible to produce the entire door from our composition, rather than just components of a door.

The door examples illustrate a useful attribute of our invention which is that different preferred embodiments can be combined to produce products.

It should be noted that in each of these above preferred embodiments and examples in the preceding pages, these processes are required to be conducted at temperatures below those in which the hydrate begins to substantially decompose, to avoid or at least minimize releasing excessive water vapor which can disrupt the manufacturing processes and/or reduce the strength and other qualities and properties of the finally cured composition.

For the purposes of this description, the term “dry” refers to ingredients or materials of the composition that are substantially free of moisture. In contrast, the term “wet” includes aqueous slurries or materials that are saturated with water to the extent that there is considerable free moisture present. Typically, in the case of inorganic hydrates, for the purposes of this description, the dry form of said hydrates contains less than 5% free moisture (% by weight). In the case of the fiber ingredients or materials, the moisture content would need to be less than 15% to be considered a dry material. Preferably, the moisture content would be less than 2% for the inorganic hydrates and less than 7% for the lignocellulosic fiber. Excess moisture can be largely removed by using desiccants and/or evaporative techniques, among others. One of ordinary skill in the art can determine an appropriate level of dryness for the various ingredients of the composition and employ appropriate techniques such as heating, ventilating, adding desiccants, etc. to achieve such levels without causing the inorganic hydrate ingredients to decompose excessively or for the fiber to become overly dried out and thereby become too weak or brittle before or during the curing cycle for the composition. A practitioner can use tests or instruments to measure moisture content or judge the relative amount of dryness or drying required by trial and error methods.

An important benefit of using dry materials is that certain polymers such as polyurethane do not require the presence of irregular shapes or voids in the inorganic hydrates or fibers to effect strong bonding. While not wishing to be bound to any theory, we believe this is because, in the case of the MDI or other isocyanate in the preferred embodiments in which the polymer is polyurethane, the isocyanate is able to form covalent bonds with the hydroxyl groups within the inorganic hydrates and also those hydroxyl groups within the lignocellulosic fibers. Covalent bonds are generally much stronger than any mechanical bonds that would be formed by the hydration and/or crystallization and/or precipitation of inorganic hydrates that basically interlock physically within compositions or materials formed in wet processes. The present invention is able to use smooth fibers and/or inorganic hydrates as well as rough or irregular ones, thereby reducing or eliminating the need to carefully discern or discriminate among the various sources and types of fiber and inorganic hydrates to effect sufficient bonding.

Finished, cured forms of the composition can be in a variety of shapes, structural and non-structural. One preferred form is that of panel boards including those of common sizes and thicknesses that are used in various aspects of construction and in other applications. Another would be in the shapes of columns or beams. The composition can be molded or otherwise formed into finished shapes directly or into rough shapes that can be subsequently finished through additional forming, molding, machining and/or other operations to whatever size, shape and finish characteristics are desired by the producer or end user.

Finished preferred product embodiments include various building and construction materials such as those described above but are not limited to these products or industries. For instance, depending on the type and orientation of the fiber as well as on the choice of polymer used and the variations of the amounts and types of ingredients used in the polymer, the finished products may be rigid or flexible. Examples of flexible products are roofing materials, both rolled roofing products and flexible shingle products. The amount of flexibility would vary depending on the type and thickness of the finished materials made of the composition as well as on the desired characteristics. Rolled roofing materials are generally made more flexible than shingles which are not required to be manufactured or transported in a rolled form.

Similarly, for use in manufacturing molded parts for use in automobiles such as dashboards, inside door panels, etc., the shape, finish and flexibility requirements of the composition are often remarkably different from those for structural building materials. Surface finish, color, texture and contour shaping is one area in particular where automotive, aeronautical and similar applications of the composition are quite different from the traditionally flat, plain and usually rigid and uncolored applications for the composition in the construction and building trades. Movie props are an example of an application area where a wide range of properties, shapes, flexibilities and finishes are involved.

An additional preferred embodiment is in the use of the composition in the manufacture of laminate flooring products in a variety of finishes, employing a variety of fiber types. A distinguishing feature of the composition of the present invention over the laminate flooring products found in the prior art is that the composition of the present invention, which can be used with any of the fiber types described herein, generally has relatively greater resistance to water and moisture. The currently produced standard products found in the prior art are not well suited for use in bathrooms or other places where they are exposed to water or high moisture, especially under chronic or prolonged conditions.

The laminate flooring products can be made with finishes and in the sizes and shapes that are similar to the standard or commonly used ones known in the art. An additional distinguishing and beneficial feature is that the laminate flooring products produced from the composition of the present invention can generally have the rigidity, flexibility and resilience parameters varied to suit producer, customer or user preferences more readily than can the common usage ones found in the prior art. Increased fire resistance is another beneficial feature.

Other preferred applications for the composition of the present invention are for use in manufacturing furniture or furniture components, insulation materials, architectural moldings, window parts, doors and door components.

While the invention has been disclosed in its preferred form, the specific embodiments thereof as disclosed and illustrated herein are not to be considered in a limiting sense, because numerous variations are possible. The subject matter of the invention includes all novel and non-obvious combinations and subcombinations of the various elements, features, functions, and/or properties disclosed herein. No single feature, function, element, or property of the disclosed embodiments is essential. The following claims define certain combinations and subcombinations which are regarded as novel and non-obvious. Other combinations and subcombinations of features, functions, elements, and/or properties may be claimed through amendment of the present claims or presentation of new claims in this or a related application. Such claims also are regarded as included within the subject matter of the present invention irrespective of whether they are broader, narrower, or equal in scope to the original claims. This invention also covers all embodiments and all applications which will be immediately comprehensible to the expert upon reading this application, on the basis of his or her knowledge and optionally simple routine tests.

We claim:

1. A fibrous cured composition comprising lignocellulosic fiber bound to an inorganic hydrate in the absence of water by a polymer.

2. The composition as claimed in claim 1 in which the lignocellulosic fiber is purposely oriented prior to being bound to the inorganic hydrate.

3. The composition as claimed in claim 1 in which the inorganic hydrate is one or more used alone or in combination from among the hydrate forms of gypsum, alumina trihydrate, lime, borax or bentonite.

4. The composition as claimed in claim 1 in which the polymer is polyurethane.

5. The composition as claimed in claim 1 in which the lignocellulosic fiber is one or more used alone or in combination from among hemp, flax, kenaf, jute, ramie or other bast fiber type plant.

6. The composition as claimed in claim 5 in which the lignocellulosic fiber also includes one or more used alone or in combination from among the numerous species of wood fiber used for manufacturing building or construction materials, furniture or any other interior or exterior use products generally described as wood or engineered wood products or components.

7. The composition as claimed in claim 1 in which the lignocellulosic fiber is or includes mechanically shredded or pulverized paper.

8. The composition as claimed in claim 2 in which the fiber is purposely oriented using natural or forced felting techniques.

9. The composition as claimed in claim 2 in which the fiber is purposely oriented using oriented strand board and/or long strand lumber manufacturing methods and equipment.

10. The composition as claimed in claim 7 in which the fiber is purposely oriented by blending or stirring mechanically shredded or pulverized paper, also referred to as fluff, into a blended mixture of inorganic hydrate and polymer.

11. The composition as claimed in claim 1 in which one or more of the polymer ingredients is not combined so as to maintain the composition in an uncured state for an indefinite period prior to curing.

12. The composition as claimed in claim 1, wherein the hydrate contains less than 5 wt % free moisture, and the fiber contains less than 15 wt % free moisture.

13. A method for producing a fibrous cured composition, said method comprising binding lignocellulosic fiber to an inorganic hydrate in the absence of water with a polymer.

14. The method as claimed in claim 13, further comprising orienting the fiber components prior to or during the combination with inorganic hydrate.

15. The method as claimed in claim 13, further comprising, prior to binding the fiber to the hydrate, mixing the fiber with water to create a pulpous aqueous slurry, agitating the slurry, prompting the fiber to felt to form a fibrous mat, and drying the mat.

16. The method as claimed in claim 13, wherein the fiber is combined with a fog, spray or waterless slurry of inorganic hydrate and polymer.

17. The method of claim 13, wherein the fiber is derived from super short hemp fibers.

18. The method of claim 13, wherein the inorganic hydrate is gypsum, and the polymer is polyurethane.

19. The method as claimed in claim 13 wherein one or more ingredients of the polymer is not initially combined so as to maintain the ability to store and/or transport an uncured mixture for an indefinite period prior to finally combining all of the ingredients to produce the cured composition.

20. An article of manufacture made from the composition of claim 1, wherein the article is an architectural molding, acoustic panel, door, marine coating, roof shingle, rolled roofing material, wallboard, laminate flooring, road repair material, concrete or asphalt crack sealer, parking structure coating, structural panel board, structural lumber, furniture or furniture component, movie prop, automotive molded component, door or window component, foamed insulating material or an adhesive material.
